(19) United States
(12) Patent Application Publication
(10) Pub. No.: US 2007/0058371 A1
(43) Pub. Date: Mar. 15, 2007

(54) Festival lamp string & its manufacturing method

(76) Inventor: Ming-Pei Chen, Fujian (CN)

Correspondence Address: CHARLES E. BAXLEY, ESQ., 90 JOHN STREET, THIRD FLOOR, NEW YORK, NY, 10038, US

(21) Appl. No.: 11/224,273

(22) Filed: Sep. 12, 2005

(51) Int. Cl. F21V 29/00

(52) U.S. Cl. 362/267; 362/249; 362/806

(57) ABSTRACT

The present invention involves to a festival lamp string comprised of cords, a certain number of sockets and coordinated illuminators; said illuminators are individually and sequentially connected with the cords, said socket is molded over the contacting portion of the illuminator and the cords by filling package. In manufacturing, firstly connects the sockets to the cords sequentially and individually, then cover the decorated cap on the illuminator respectively, next place the assembled cords and illuminator and the decorated cap into the inside of jetting molder so that the contacting portions of the cords and illuminator and the decorated cap are exactly laid on the die cavity, finally inject resinoid into die so as to fill up all the cavity of the die to form a socket covering the contacting portions of the cords and illuminator and the decorated cap, the temperature of the resinoid is lower than 80° C., so a festival lamp string with decorated cap is manufactured. It possesses some features, such as simple structure, less parts and good tightness which can be used in wider range whatever commercial power or not, wherever inside or outside, and it is also to simplify operation, improve work safety and up-to-standard rate, and suit to industrial scale production.

### BACKGROUND OF THE INVENTION

1. Field of the Invention

The present invention relates to a festival lamp string and its manufacturing method.

2. Description of Prior Art

In accordance with the conventional festival lamp string, as shown in FIG. 1 and FIG. 2, it is comprised of cords 1′, a certain number of sockets 2′, lamp-holders 3′ and illuminators 4′ (LED or bulbs). In manufacturing, firstly connect the sockets 2′ to the cords 1′ sequentially and individually, and set the illuminators upon the lamp-holders 3′ separately, then, plug the assembled lamp-holders 3′ into the connected sockets 2′ in socket joint to combined festival lamp string. But this structure exist some shortcomings as followings:
1. more complicated structure of parts and operation processes, and manually operated plugging process and other processes so as not to suit to automatically manufacturing in scale production;
2. due to socket joint, there are gaps existed on the joint portions of the sockets 2′ and the lamp-holders 3′, so as to occur poor leak tightness, further to cause electrical leakage easily, so if taking commercial power as power source, the goods are not suited to use at outside; if it is used in outside, the safety power should be or lower than 24V;
3. due to the gaps existed between the sockets 2′ and the lamp-holders 3′, and poor leak tightness, the contacting points of the sockets 2′ and the lamp-holders 3′ are easily to be oxidized, etched, and even occur poor contact between them, further to cause lamp string out of work, or increasing contacting resistance to much to generate big deal heat to occur fire.

In accordance with a common lamp string in the market so far, as shown in FIG. 3 to FIG. 5, it is comprised of cords 1″, a certain number of lamp-holders 2″, illuminators 3″ (LED or bulbs) and spacing pins 4″. In manufacturing, said illuminators 3″ are connected to the cords 1″ sequentially and individually, and set said spacing pins 4″ upon between the both cords 1″ below the illuminators separately and sequentially, as shown in FIG. 4, so as to space the both cords 1″ with the spacing pin 4″ for locating them to prevent them from happening short-circuit occurred under an extra big pressure as injection molding, meanwhile as the requirement of the design, the illuminators 3″ are individually covered with a decorated cap 5″ on each, then place the assembled cords 1″, illuminators 3″ and the spacing pins 4″ into the inside of injection molder, finally inject hot plastic into the molder to form a lamp-holder 2″ holding said cords 1″, illuminators 3″ and the spacing pins 4″ in, as shown in FIG. 5, such as finishing a festival lamp string. But the structure of the lamp string manufactured in above-said method exist some shortcomings as follows:
1. the workers has to work with injection molding machines and suffer high temperature and high air pressure, so the operation environment is hidden with dangers, and poor safety;
2. the molding temperature of the thermoplastic lamp-holder 2″ is higher than 160° C., it also affects the illuminator 3″ (LED) to overheat, further to affect its optoelectronic performance, even occur damage;
3. because the injection molder is metal, as opening or closing the metal injection molder, the illuminator 3″ and cords 1″ pre-set on the inside molder are easy to be damaged to generate rejected goods, if these rejected goods are not found in time, so that they are to enter the market, the safety of the users is easy to be threatened;
4. before injection molding, the assembled cords 1″, illuminator 3″ and the spacing pin 4″ have to be arranged into the inside of the injection molder as embedding, so it occurs the operation more complication with lower work efficiency;
5. for preventing the cords 1″ from short circuit under extra pressing force as molding the lamp-holder 2″, increasing a part as spacing pin for separating and locating the both cords 1″, so that the number of parts is increased, and the structure is complicated, the manual operation processes are increased too, meanwhile not facilitating to industrial scale production.

In a word, the conventional festival lamp string and its manufacturing method exists several improving respects.

### OBJECTS AND SUMMARY OF THE INVENTION

For overcoming the above said shortcomings of the prior art, it is therefore a main object of the present invention to provide a festival lamp string with simple structure, less parts and good tightness which can be used in wider range whatever commercial power or not, wherever inside or outside.

The another object of the present invention is to provide said lamp string's manufacturing method, so as to facilitate to simplify operation, improve work safety and up-to-standard rate, and suit to industrial scale production.

These objects are achieved by the present invention, wherein said festival lamp string is comprised of cords, a certain number of sockets and coordinated illuminators; said illuminators are individually and sequentially connected with the cords, said socket is molded over the contacting portion of the illuminator and the cords by filling package to form a festival lamp string.

Said illuminator also can be covered with a decorated cap before molding, the socket is molded over the contacting portion of the illuminator, cords and the cap to form a festival lamp string.

The method of said festival lamp string, firstly connects the sockets to the cords sequentially and individually, and place the assembled cords and illuminator into the inside of jetting molder so that the contacting portions of the cords and illuminator are exactly laid on the die cavity, finally inject resinoid into die so as to fill up all the cavity of the die to form a socket covering the contacting portions of the cords and illuminator, the temperature of the resinoid is lower than 80° C., so a festival lamp string is manufactured.

In accordance with the design, after connection process-connecting illuminators to the cords respectively, the decorated caps can be covered on the illuminators sequentially, then place the assembled cords and illuminator with the decorated cap into the inside of jetting molder so that the contacting portions of the cords and illuminator are exactly laid on the die cavity, finally inject resinoid into die so as to fill up all the cavity of the die to form a socket covering the contacting portions of the cords and illuminator and the decorated cap, the temperature of the resinoid is lower than 80° C., so a festival lamp string is manufactured.

Due to utilizing above-mentioned structure, the present invention possesses follows features:
1. simplify the structure comparing with the convention technology, decrease the number of the parts, simplified manufacturing method makes the Industrial scale production possible;
2. utilizing filling-packaged socket, wrapping the contacting portions of the cords and illuminator improves the tightness, and efficiently avoids the contacting points oxidized, etched and leakage happened, therefore the safety is improved, and it can be used in wider range including outside door and commercial power supply;
3. applying filling molding, under 80° C. working environment improves work safety without any danger;
4. the filling package process is operated in normal temperature and pressure, so the illuminators will not be affected so as to guarantee the optoelectronic performance;
5. the filling molder is made of plastic, so in processing, the illuminators and cords may not be hurt and damaged, therefore the product quality is guaranteed, meanwhile the use of goods is more safety;
6. In filling molding process, the pre-assembled cords and illuminator are placed into the die cavity in one time to carry out filling package; it simplifies operation steps, and improves work efficiency.

### BRIEF DESCRIPTION OF THE DRAWINGS

FIG. 1 is a scheme of the prior art in the conventional technology.

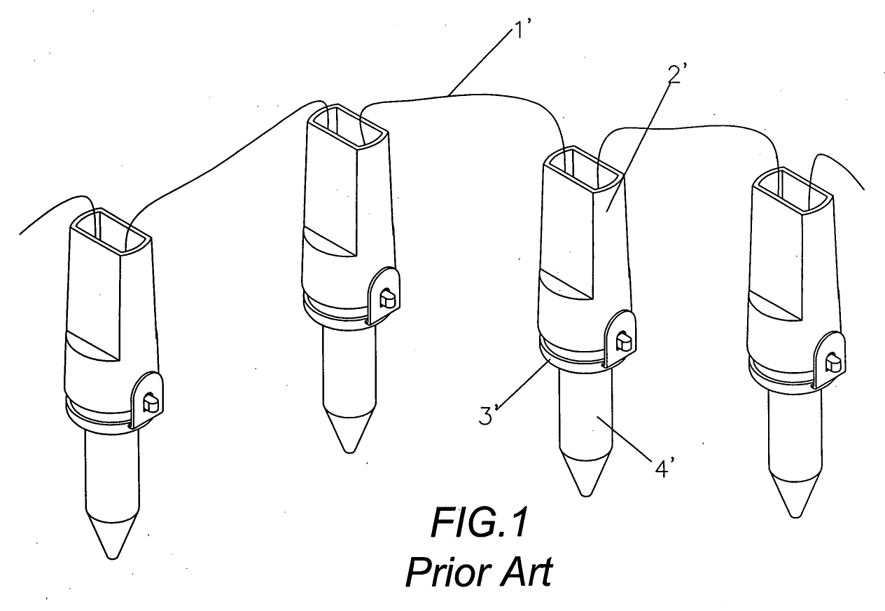

FIG. 2 is an exploded view showing one unit of the prior art in the conventional technology.

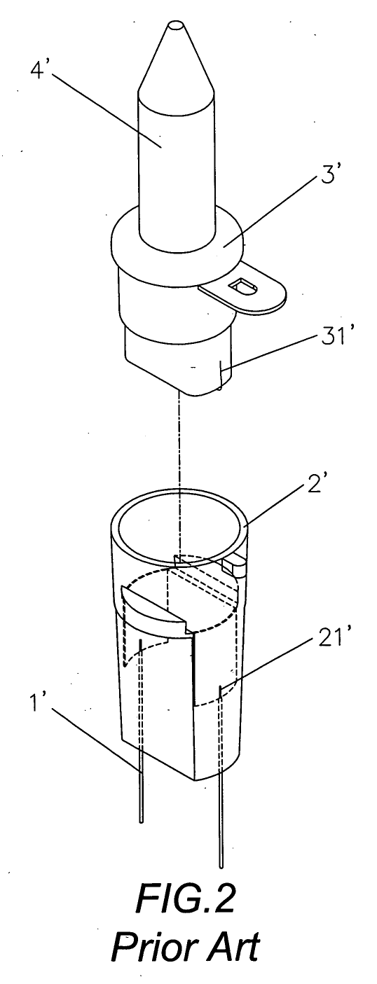

FIG. 3 is a scheme showing one unit of the prior art in common technology.

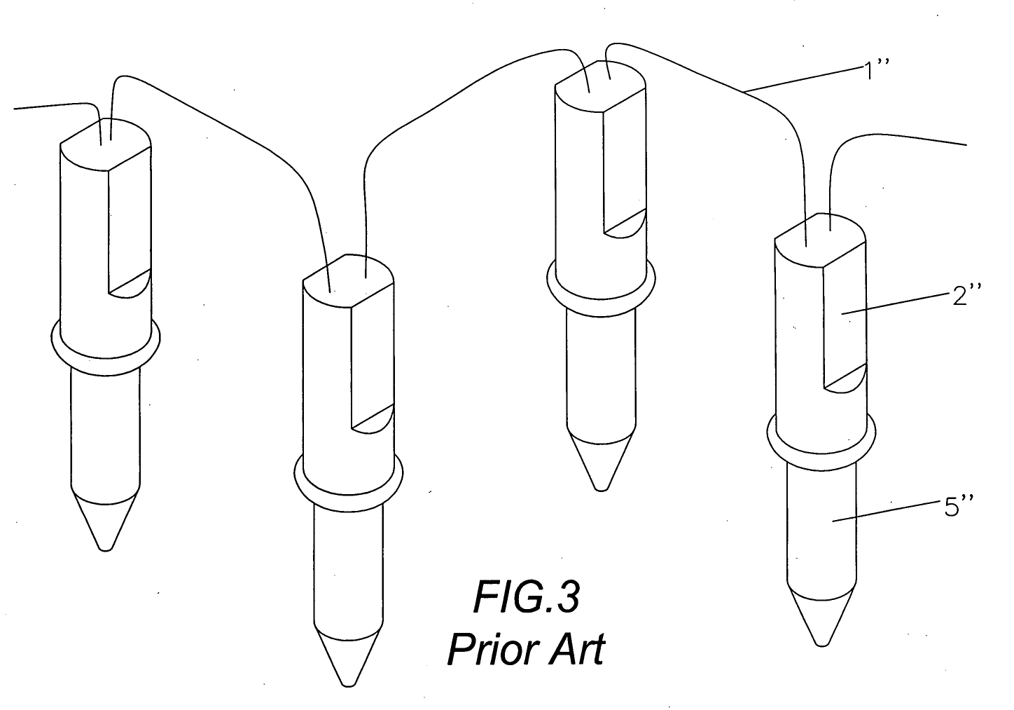

FIG. 4 is an exploded view showing one unit in combination of the prior art in common technology.

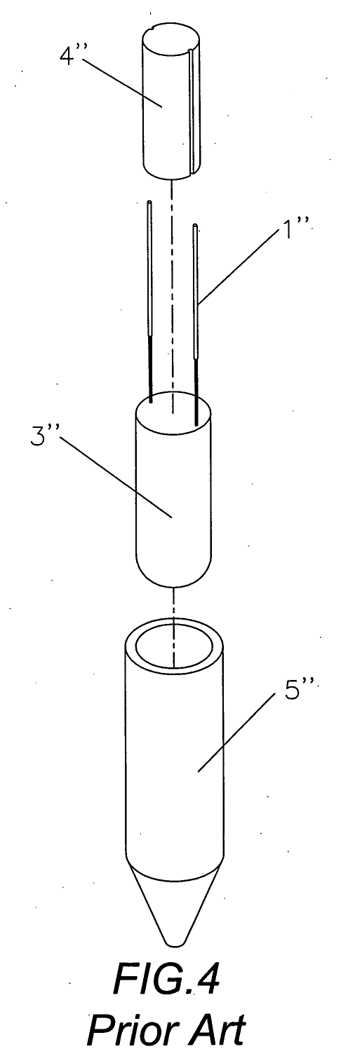

FIG. 5 is a sectional view showing combined one unit of the prior art in common technology.

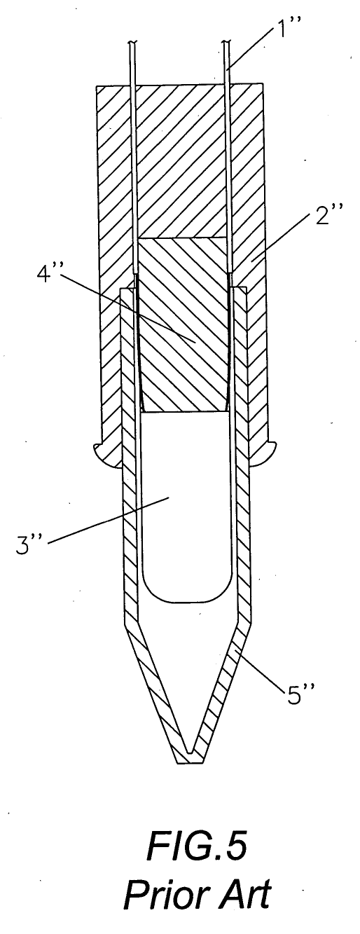

FIG. 6 is a scheme of the present invention.

FIG. 7 is a sectional view showing one unit of the present invention.

FIG. 8 is a sectional view showing the filling package process of the present invention.

FIG. 9 is a sectional view showing one unit in another embodiment of the present invention.

### DETAILED DESCRIPTION OF PREFERRED EMBODIMENTS

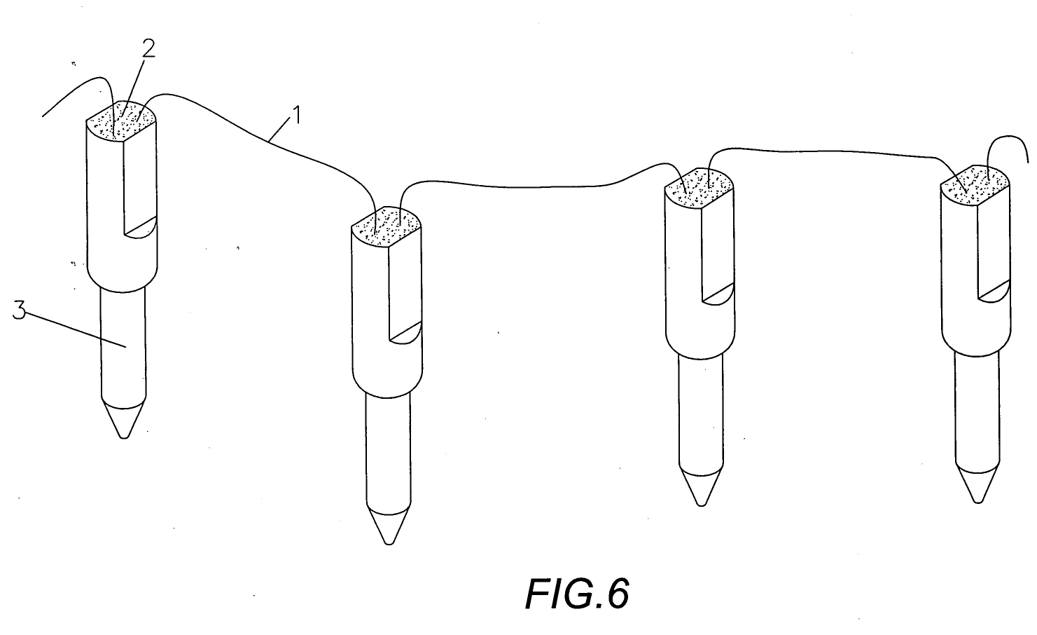

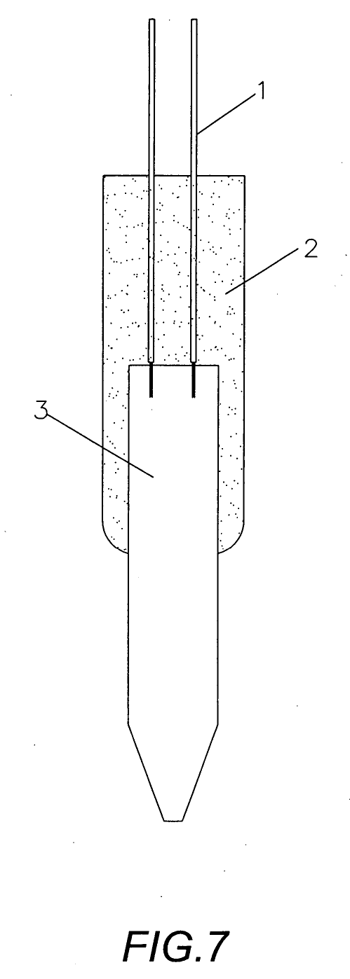

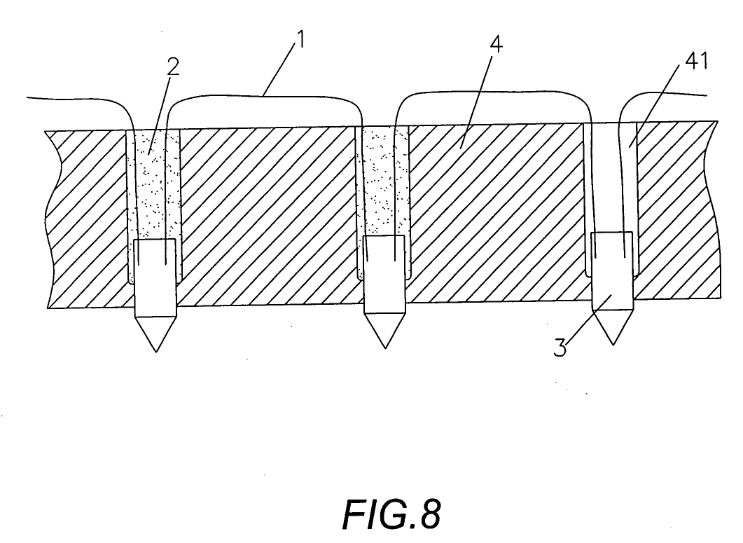

Referring to FIG. 6 and FIG. 7, the festival lamp string of the present invention is comprised of cords 1, a certain number of sockets 2 and coordinated number of illuminators 3. Said illuminator 3 can be LED or bulb, said illuminators 3 are connected to the cords 1 respectively and sequentially, said socket 2 is molded in the filling package process (as shown in FIG. 8) covering the contacting portions of the cords 1 and illuminator 3 so as to hold them in, so a festival lamp string is finished.

The manufacturing method is as follows:
1. connect the certain number of illuminators 3 to the cords 1 respectively and sequentially;
2. place the pre-assembled cords 1 and illuminator into filling molder 4, referring to FIG. 8, so that the contacting portions of the cords 1 and illuminator 3 exactly lay on the die cavity 41;
3. In filling package, the socket 2 molded of normal or middle temperature resinoid in the die cavity 41 covers the contacting portions of the cords 1 and the illuminator 3 fully, filling package temperature should be lower than 80° C., and the pressure of filling package is in normal, so a festival lamp string is finished.

Comparing with the common festival lamp string, the present invention exists following advantages:
1. there are only two kinds of parts including cords 1 and illuminator 3 with a socket 2 filling-molded in the goods, so comparing with the common technology, it simplifies the structure, and decreases the number of the parts, the simplified manufacturing method makes the Industrial scale production possible;
2. utilizing filling-packaged socket 2, wrapping the contacting portions of the cords 1 and illuminator 3 improves the tightness without any gap, and efficiently avoids the contacting points oxidized, etched and leakage happened, therefore the safety is improved, and it can be used in wider range including outside door and commercial power supply;
3. applying filling molding, under 80° C. working environment improves work safety without any danger;
4. the filling package process is operated in normal temperature and pressure, so the illuminators 3 will not be affected so as to guarantee the optoelectronic performance;
5. the filling molder 4 is made of plastic, so in processing, the illuminators 3 and cords 1 may not be hurt and damaged, therefore the product quality is guaranteed, meanwhile the use of goods is more safety;
6. In filling molding process, the pre-assembled cords 1 and illuminator 3 are placed into the die cavity of the filling molder 4 in one time to carry out filling package together, as shown in FIG. 8; it simplifies operation steps, and improves work efficiency.

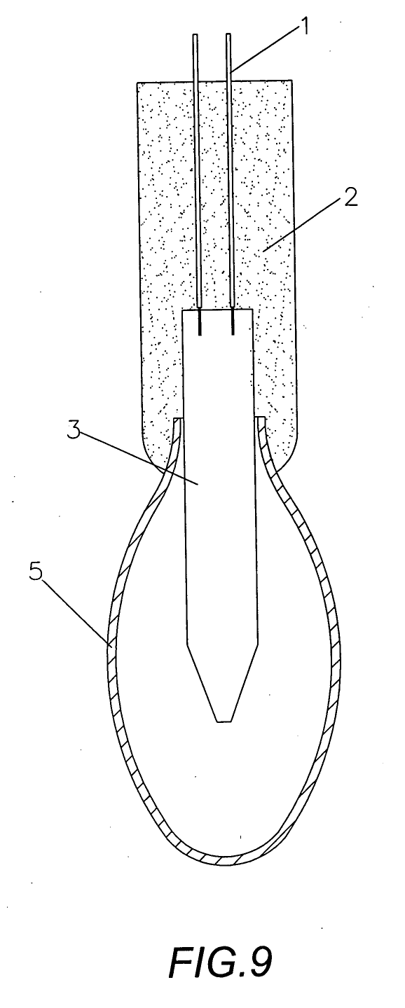

Referring to FIG. 9, depending to the necessary of the design, the illuminator 3 can be covered with a decorated cap 5, the socket 2 is molded covering the contacting portions of cords 1 and illuminator 3 and the decorated cap 5 exactly and fully to finish a festival lamp string with decorated cap 5.

The method of manufacturing said festival lamp string with cap is as follows steps:
1. connect the certain number of illuminators 3 to the cords 1 respectively and sequentially;
2. according to design, cover the decorated caps 5 on the illuminators 3 respectively;
3. place the pre-assembled cords 1, decorated cap 5 and the illuminator 3 into the plastic filling molder 4, so that the contacting portions of the cords 1, cap 5 and illuminator 3 are exactly laid on the die cavity 41;
4. By the advantage of filling package process, the socket 2 is molded of normal or middle resinoid just covering the contacting portions of cords 1 and illuminator 3 and the decorated cap 5 fully, filling package temperature should be lower than 80° C., and the pressure of filling package is in normal, so a festival lamp string with decorated caps is finished.

I claim:

1. A festival lamp string comprised of cords, a certain number of sockets and coordinated number of illuminators, wherein said illuminators are individually and sequentially connected with the cords, said socket is molded over the contacting portion of the illuminator and the cords by filling package to form a festival lamp string.

2. A festival lamp string as claimed in claim 1, wherein said illuminator is covered with a decorated cap, the socket is molded in filling package covering the contacting portions of cords, illuminator and decorated cap exactly holding them in to form a festival lamp string with decorated cap.

3. A manufacturing method of the festival lamp string as claimed in claim 1, wherein firstly connects the sockets to the cords sequentially and individually, and place the assembled cords and illuminator into the inside of jetting molder so that the contacting portions of the cords and illuminator are exactly laid on the die cavity, finally inject resinoid into die so as to fill up all the cavity of the die to form a socket covering the contacting portions of the cords and illuminator, the temperature of the resinoid is lower than 80° C., so a festival lamp string is manufactured.

4. A manufacturing method of the festival lamp string as claimed in claim 2, wherein firstly connects the sockets to the cords sequentially and individually, then cover the decorated cap on the illuminator respectively, next place the assembled cords and illuminator and the decorated cap into the inside of jetting molder so that the contacting portions of the cords and illuminator and the decorated cap are exactly laid on the die cavity, finally inject resinoid into die so as to fill up all the cavity of the die to form a socket covering the contacting portions of the cords and illuminator and the decorated cap, the temperature of the resinoid is lower than 80° C., so a festival lamp string with decorated cap is manufactured.

5. A string lamp cap as claimed in claim 1, wherein said cramping clip provides a socket for holding the bulb base in; for this purpose, the sectional area of the socket is a bit smaller than the bulb base, within two opposite open notches set upon the socket, coordinating to it a through hole is built upon the cramping clip and connects to the socket via a notch.

6. A string lamp cap as claimed in claim 1, wherein said transparent cup has a flange at the rim of the open mouth outward.
